(19) United States
(12) Patent Application Publication
(10) Pub. No.: US 2018/0246965 A1
(43) Pub. Date: Aug. 30, 2018

(54) Terminal Emulator-Based Online Search

(71) Applicant: CA, Inc., New York, NY (US)

(72) Inventors: Robert Skorpil, Dobrejovice (CZ); Kristian Klima, Prague (CZ)

(21) Appl. No.: 15/443,010

(22) Filed: Feb. 27, 2017

(51) Int. Cl. G06F 17/30; G06F 9/455

(52) U.S. Cl. CPC G06F 17/30864; G06F 17/30876; G06F 9/455; G06F 17/30899; G06F 17/30914

(57) ABSTRACT

A computing device transmits a help key code from a terminal emulator to a remote mainframe application while a cursor within a display of the terminal emulator is over a visible field. The computing device monitors a hidden field within the display of the terminal emulator for an update. The update comprises text received from the remote mainframe application responsive to the help key code. Responsive to the update, the computing device performs a search using the text as a search term.

### BACKGROUND

The present disclosure relates to a terminal emulator that communicates with a mainframe application, and more particularly to a terminal emulator that performs searches using information received from the mainframe application.

Mainframe computers, or “mainframes,” are large, complex computing systems primarily used by large corporate entities to execute various enterprise applications. Such applications include, but are not limited to, critical applications related to bulk data processing, process control, hosting, ecommerce, software development and/or testing, planning, and finance.

Users typically interact with applications executing on the mainframe computer using a software application known as a terminal emulator. A terminal emulator provides a user with an interface through which the user may, e.g., browse, edit, and/or delete data. Traditionally, the functionality of the terminal emulator itself is quite limited. Many terminal emulators provide little function beyond establishing a Telnet connection with the mainframe and displaying characters or blocks of text provided by the mainframe.

### BRIEF SUMMARY

The present disclosure provides methods, apparatus, systems, and non-transitory computer readable mediums storing computer program products. In particular, one or more embodiments include a method implemented by a computing device. The method comprises transmitting a help key code from a terminal emulator to a remote mainframe application while a cursor within a display of the terminal emulator is over a visible field. The method further comprises monitoring a hidden field within the display of the terminal emulator for an update. The update comprises text received from the remote mainframe application responsive to the help key code. The method further comprises, responsive to the update, performing a search using the text as a search term.

Other embodiments include a computing device. The computing device comprises interface circuitry and processing circuitry communicatively coupled to the interface circuitry. The interface circuitry is configured to exchange signals with a remote mainframe application. The processing circuitry is configured to transmit a help key code to the remote mainframe application from a terminal emulator via the interface circuitry while a cursor within a display of the terminal emulator is over a visible field. The processing circuitry is further configured to monitor a hidden field within the display of the terminal emulator for an update. The update comprises text received from the remote mainframe application responsive to the help key code. The processing circuitry is further configured to, responsive to the update, perform a search using the text as a search term.

Yet other embodiments include a non-transitory computer readable medium storing a computer program product for controlling a programmable computing device. The computer program product comprises software instructions that are executable to cause the programmable computing device to transmit a help key code from a terminal emulator to a remote mainframe application while a cursor within a display of the terminal emulator is over a visible field, and monitor a hidden field within the display of the terminal emulator for an update. The update comprises text received from the remote mainframe application responsive to the help key code. The software instructions are executable to further cause the programmable computing device to, responsive to the update, perform a search using the text as a search term.

Of course, those skilled in the art will appreciate that the present embodiments are not limited to the above contexts or examples, and will recognize additional features and advantages upon reading the following detailed description and upon viewing the accompanying drawings.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter generally, whereas discussion of a specific instance of an illustrated element will append a letter designation thereto (e.g., discussion of a visible field 210, generally, as opposed to discussion of particular instances of visible fields 210a, 210b).

FIG. 1 is a block diagram illustrating an example computing environment according to one or more embodiments of the present disclosure.

FIG. 2 is an illustration of an example display of a terminal emulator according to one or more embodiments of the present disclosure.

FIG. 3 is a block diagram illustrating an example of workflow for generating a content mapping according to one or more embodiments of the present disclosure.

FIG. 4 is a flowchart illustrating an example method according to one or more embodiments of the present disclosure.

FIG. 5 is a flowchart illustrating a more detailed example method according to one or more embodiments of the present disclosure.

FIG. 6 is a block diagram illustrating example hardware of a computing device according to one or more embodiments of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

For clarity in understanding the disclosure below, to the extent that “one of” a conjunctive list of items (e.g., “one of A and B”) is discussed, the present disclosure refers to one (but not both) of the items in the list (e.g., an A or a B, but not both A and B). Such a phrase does not refer to one of each of the list items (e.g., one A and one B), nor does such a phrase refer to only one of a single item in the list (e.g., only one A, or only one B). Similarly, to the extent that “at least one of” a conjunctive list of items is discussed (and similarly for “one or more of” such a list), the present disclosure refers to any item in the list or any combination of the items in the list (e.g., an A only, a B only, or both an A and a B). Such a phrase does not refer to at least one of each of the items in the list (e.g., at least one of A and at least one of B).

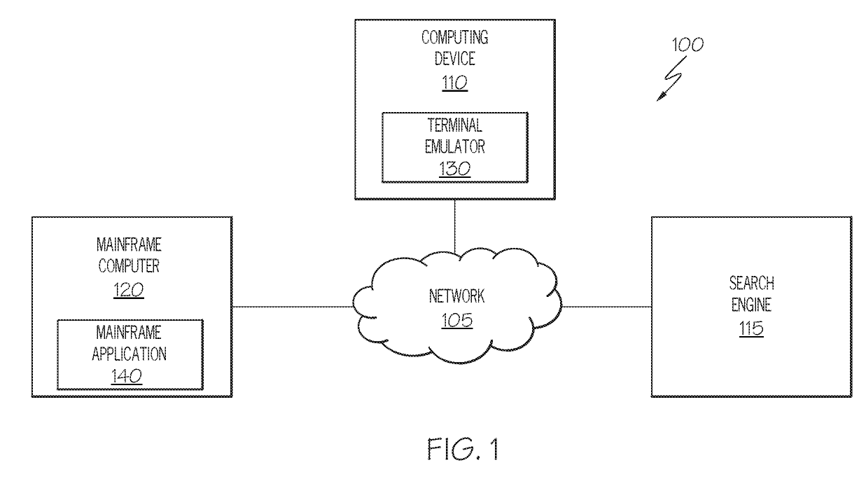

Turning to the figures, FIG. 1 illustrates an example network environment 100 that includes a computing device 110, a mainframe computer 120, a search engine 115 and a network 105. The computing device 110, mainframe computer 120, and search engine 115 are each communicatively connected to, and exchange signals with each other via, the network 105.

The mainframe computer 120 is configured to execute a mainframe application 140, typically by loading instructions of the mainframe application 140 from memory circuitry into processing circuitry of the mainframe computer 120 (not shown in FIG. 1). The mainframe application 140 executing on the mainframe computer 120 is configured to exchange signals via network 105 with a terminal emulator 130 executing on the computing device 110. In particular, the mainframe application 140 and terminal emulator 130 may exchange signals using a 3270 protocol (e.g., Telnet 3270), in some embodiments. Typical examples of the mainframe computer 120 include a computing platform based on the IBM System/360, its architectural successors (such as z/Architecture, Enterprise Systems Architecture/390 (ESA/390), and ESA/370 systems), and architecturally similar hardware platforms manufactured by other vendors. Typical examples of the mainframe application 140 include Interactive System Productivity Facility (ISPF), and Time Sharing Option (TSO).

The computing device 110 is configured to execute the terminal emulator 130, typically by loading instructions of the terminal emulator 130 from memory circuitry into processing circuitry of the computing device 110 (not shown in FIG. 1). The terminal emulator 130 is configured to exchange signals with the mainframe application 140 executing on the mainframe computer 120, and with the search engine 115, via network 105. The terminal emulator 130 may be block-oriented and/or character-oriented, according to embodiments. In particular, the terminal emulator 130 may communicate with the mainframe application 140 via a 3270 protocol (e.g., Telnet 3270). The terminal emulator 130 performs terminal emulation to provide a user with remote access to the mainframe application 140. Typical examples of the computing device 110 include a personal computer, a laptop computer, a desktop computer, a workstation, a smartphone, a tablet computer, a wearable computer, and/or a smart appliance. Other examples of the computing device 110 include a server computer, a server cluster, network attached storage, and/or a storage area network.

The search engine 115 is configured to exchange signals with the computing device 110 via the network 105, e.g., using the Hypertext Transfer Protocol (HTTP). In particular, the search engine 115 is configured to receive a search query including one or more search terms (e.g., from the terminal emulator 130 executing on the computing device 110) and respond (e.g., to the terminal emulator 130) with relevant search results. The search engine 115 may be a general purpose search engine (e.g., a search engine provided to users Internet-wide for all kinds of searches) or a special purpose search engine (e.g., a search engine specifically for locating information about the mainframe application 140 and/or the mainframe computer 120). In some embodiments, the search engine 115 may be a website-specific search engine.

The network 105 includes one or more physical devices and/or signaling mediums capable of exchanging communication signals between the computing device 110, mainframe computer 120, and search engine 115. Examples of such a network 105 include (but are not limited to) one or more of: the Internet (or a portion thereof); one or more local area networks; one or more wireless networks; one or more cellular networks; one or more Internet Protocol-based networks; one or more Ethernet networks; one or more optical networks; and/or one or more circuit switched networks. Such a network 105 may comprise any number of networking devices such as routers, gateways, switches, hubs, firewalls, and the like (not shown) supporting the exchange of such communication signals.

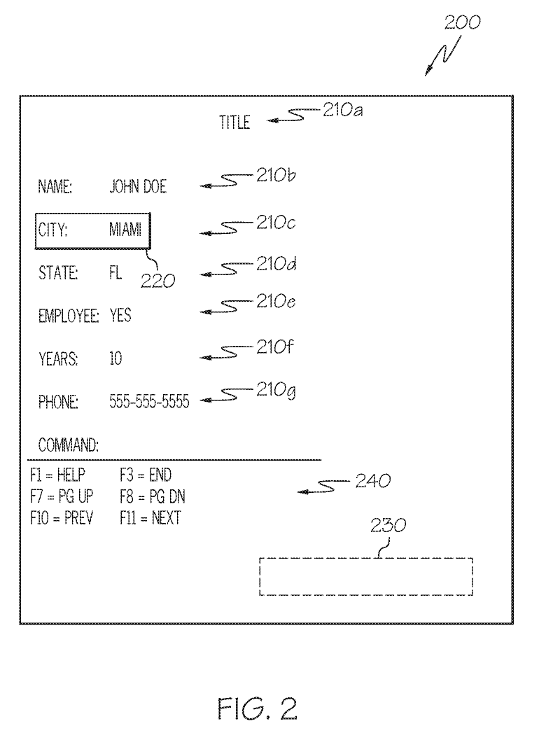

FIG. 2 illustrates an example display 200 of the terminal emulator 130. In this particular example, the terminal emulator 130 is communicating with a mainframe application 140 that stores and retrieves employee records. The display 200 in this example is text-based and comprises a plurality of visible fields 210a-g, a cursor 220, a hidden field 230, and informational text 240. Although the example of FIG. 2 includes seven visible fields 210a-g, other embodiments may include fewer, more, or different visible fields 210.

According to embodiments, one or more visible fields 210 are selectable by positioning the cursor 220. For example, a visible field 210 may be selectable in order to permit data entry relevant to that visible field 210. In the example of FIG. 2, visible fields 210b-g are each selectable using the cursor 220 (of which visible field 210c is presently selected). Visible field 210a is not selectable using the cursor 220. In some embodiments, visible fields 210 that are selectable using the cursor 220 may permit a user to operate on (e.g., edit) the data within that field, whereas non-selectable fields may provide a user with information while also being used by the mainframe application 140 for other purposes, as will be explained further below. Although this example includes six visible fields 210b-g that are selectable using cursor 220 and one visible field 210a that is not selectable using cursor 220, other embodiments may include fewer, more, or different numbers of selectable and/or non-selectable fields. In particular, some embodiments may include no non-selectable fields.

The informational text 240 is displayed for informational purposes, e.g., to provide the user with instructions or guidance. For example, as shown in FIG. 2, the informational text may inform a user of functions that are accessible to the user by pressing certain keys. In the example of FIG. 2, pressing the F1 key will cause the terminal emulator 130 to transmit a corresponding key code to the mainframe application 140 to obtain help with respect to the visible field 210c presently selected by the cursor 220. Although the example of FIG. 2 includes informational text 240 in the display 200, other embodiments may include less, more, different, or no informational text 240.

Hidden field 230 is a portion of the display 200 that appears to be empty, yet may be populated with hidden data received from the mainframe application 140. For example, text within the hidden field 230 may be configured to be the same color as a background color of the display 200, such that a user would not be able to distinguish the text from the background when output by the terminal emulator 130. According to embodiments, the hidden field 230 provides the terminal emulator 130 with information that the terminal emulator 130 may use to perform a search. In particular, in response to a keypress corresponding to a help key code that, when transmitted to the mainframe application 140, invokes a help function for the currently selected visible field 210c, the terminal emulator 130 may monitor the hidden field 230 for an update comprising text and subsequently use that text to perform a search. In particular, the text comprised in the update may be text that, when provided to the search engine 115, will produce search results relevant to the selected visible field 210c.

With respect to the example of FIG. 2, visible field 210c is presently selected. The visible field 210c is a field for setting and displaying the city of the presently displayed employee. In response to the user pressing the F1 help function key, the terminal emulator may transmit a corresponding help key code corresponding to the F1 keypress, and monitor the hidden field 230 for an update comprising text 210c, which was received from the mainframe application 140 in response to the help key code. The text of this update, for example, may be the string of characters “company cities.” Responsive to the update, the terminal emulator 130 may perform a search using the text “company cities” as a search term by sending the text to search engine 115, e.g., via a web browser. The search engine 115 may respond with search results that, for example, may be useful in determining which cities are acceptable to enter when modifying the visible field 210c. In some embodiments, the search engine 115 returns a plurality of search results, and the user may select content therefrom that is relevant to the selected visible field 210c. To select such content, a user may, for example, select a URL of a result in the plurality of search results received from the search engine 115.

The process of finding content that is relevant to the selected visible field 210c may not always be straightforward. For example, the user may, at times, be required to comb through the search results to locate content of relevance. This may be burdensome to do, particularly if a user (or group of users) is forced to do so each time the help key is pressed within the terminal emulator 130. Accordingly, in some embodiments, once relevant content is identified from search results, the computing device 110 may store a mapping between the text in the hidden field and the content selected by the user as relevant to the selected visible field 210c. Once this mapping is stored, the computing device 110 may use the mapping to identify the corresponding content, e.g., to avoid a further search using that same text.

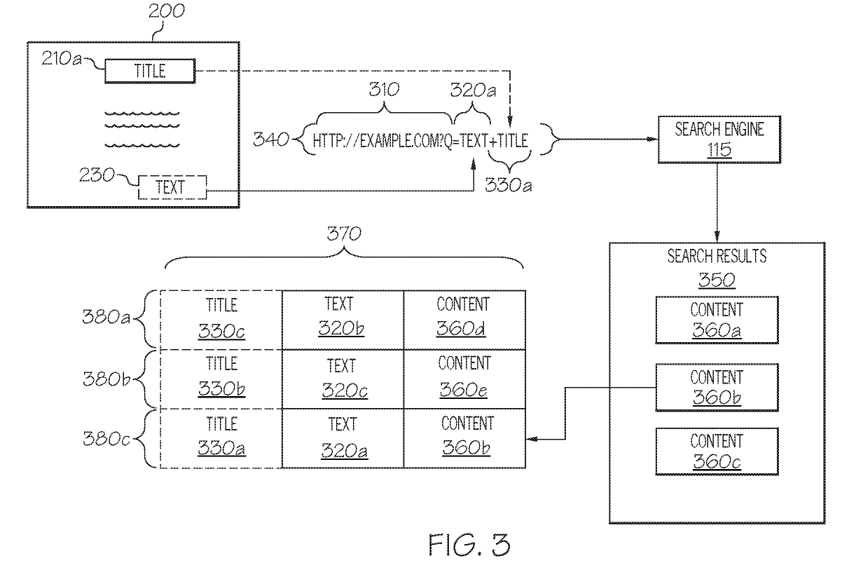

For example, as shown in FIG. 3, the hidden field 230 of display 200 of the terminal emulator 130 has been updated by the mainframe application 140 with text 320a. According to this example embodiment, the computing device 110 constructs a Uniform Resource Locator (URL) 340 for the search by adding the text 320a to a base URL 310. In some embodiments, the computing device 110 may construct the URL 340 for the search using data in one or more visible fields 210. For example, as shown in FIG. 3, the text 320a, and the visible field data 330a (which is a title of the mainframe application 140 according to this example) may both be added to base URL 310 to construct the URL 340 for the search.

The computing device 110 uses the URL 340 to transmit an HTTP request (e.g., an HTTP GET message using the text 320a as a parameter) to search engine 115 to perform a search, and the computing device 110 receives a plurality of search results 350 from the search engine 115 in response. Responsive to content 360b being selected from the plurality of search results 350 (e.g. by a user), the computing device 110 stores a mapping 380c between the text 320a and the content 360b selected from the plurality of search results 350, e.g., in a database 370 of text 320 to content 360 mappings 380 as shown in FIG. 3. In the particular example of FIG. 3, the mapping 380c is stored in a database 370 that already contains two other mappings 380a-b produced from previous searches. In this particular example, mapping 380a maps text 320b and visible field data 330c to content 360d. Further, mapping 380b maps text 320c and visible field data 330b to content 360e.

This content 360b may be, for example, a URL, returned in the search results 350, identifying a location at which information deemed helpful by the user is located. The data 330a may also be stored in this mapping 380c in some embodiments (e.g., in one or more embodiments in which the data 330a was a search term transmitted to the search engine 115 along with the text 320a). Once the mapping 380c is stored, and in response to a further update of the hidden field 230 with text 320a, the computing device 110 may use the mapping 380c to identify the content 360b, e.g., without performing a further search using the text 320a.

The example of FIG. 3 includes only a single base URL 310 that may be used by the computing device 110 to construct the URL 340 for the search. This base URL 310 may be the root URL to a preferred search engine 115. For example, base URL 310 may be the address of a particular remote Internet-based search engine. Additionally or alternatively, base URL 310 may be the address of an internal intranet search engine, or may even be an address to a search engine running on the computing device 110 itself, according to embodiments. For example, the search engine 115 may be a document search facility executing on the computing device 110 or on a remote computer, such that product documentation pertaining to the mainframe application 140 and/or mainframe computer 120 may be searched responsive to receiving text 320a.

Other embodiments include a plurality of base URLs (not shown), and the computing device 110 may be configured to select the base URL 310 from the plurality of base URLs. For example, each base URL 310 in the plurality of base URLs may be the address of a different search engine 115, and by selecting a base URL 310 from the plurality of base URLs, the computing device 110 may select which search engine 115 to use for performing the search (e.g., using the text 320a as a search term). In such embodiments, the computing device 110 may select the base URL 310 from the plurality of base URLs based on, for example, the data 330a in visible field 210a. Additionally or alternatively, the computing device 110 may select the base URL 310 based on the text 320a in the hidden field 230.

For example, the terminal emulator 130 may be configured to communicate with a plurality of mainframe applications, and visible field 210a indicates an identifier (e.g., a title) of the particular mainframe application 140 that the terminal emulator 130 is presently interfacing with. In some embodiments, the terminal emulator 130 may select a base URL 310 based on this identifier, e.g., to select a search engine 115 that corresponds to the mainframe application 140. For example, if the mainframe application 140 is a non-public application used only internally within a particular business concern, the computing device 110 may select a base URL 310 that is within a corporate intranet. Alternatively, for example, if the mainframe application 140 is a well-known, public, standard application, the computing device 110 may select a base URL 310 of a remote Internet-based search engine. Other embodiments may include selecting other search engines 115 for other reasons.

In addition to the above, according to some embodiments, other mappings 380a-b may already be in the database 370 when mapping 380c is generated and/or stored. One or more of these other mappings 380a-b may, in some embodiments, be preconfigured in the database 370 and/or have been generated and stored as a result of previous searches performed by the computing device 110 consistent with the above. Other embodiments may include any number of mappings 380, which may be generated and/or stored before and/or after mapping 380c discussed above.

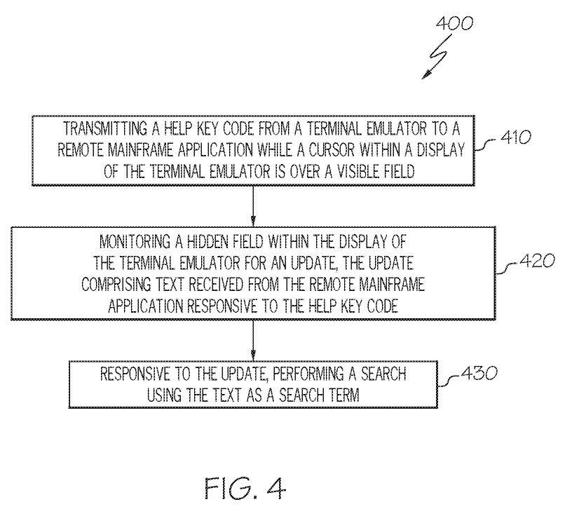

In view of the above, FIG. 4 illustrates an example method 400 implemented by a computing device 110, according to one or more embodiments of the present disclosure. The method 400 comprises transmitting a help key code from a terminal emulator 130 to a remote mainframe application 140 while a cursor 220 within a display 200 of the terminal emulator 130 is over a visible field 210c (block 410). The method 400 further comprises monitoring a hidden field 230 within the display 200 of the terminal emulator 130 for an update comprising text 320a that was received from the mainframe application 140 in response to the help key code (block 420). The method 400 further comprises, responsive to the update, performing a search using the text 320a as a search term (e.g., by transmitting the text 320a to a remote Internet-based search engine 115) (block 430).

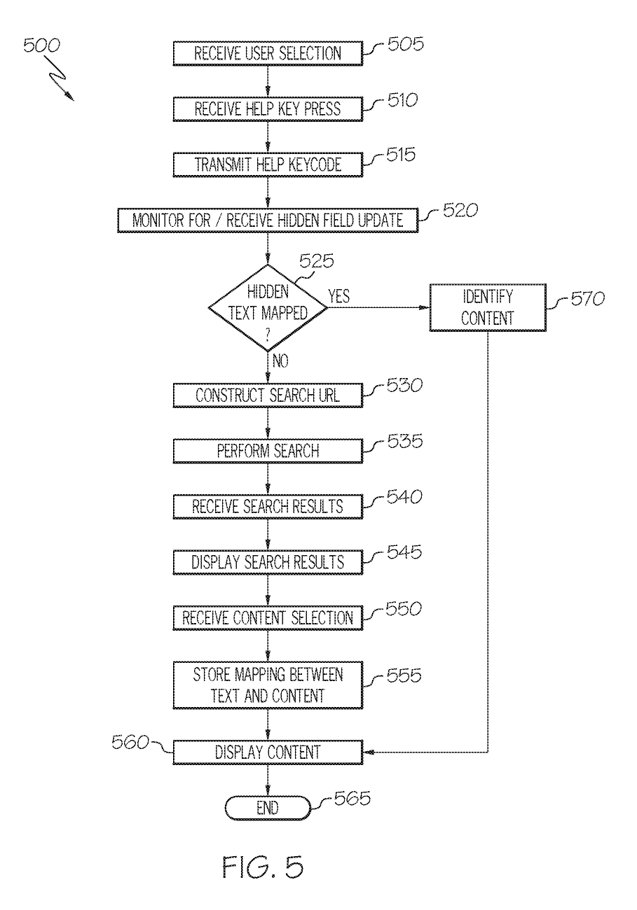

FIG. 5 illustrates a more detailed example method 500 implemented by a computing device 110, according to one or more embodiments of the present disclosure. According to the more detailed example method 500, the computing device 110 receives user input that selects a visible field 210c by positioning the cursor 220 over that visible field 210c (block 505). The computing device 110 then receives a keypress (e.g., an F1 function key press) corresponding to a help key code (block 510). In response, the terminal emulator 130 executing on the computing device 110 transmits the help key code to a remote mainframe application 140 while the cursor 220 within the display 200 of the terminal emulator 130 is over the visible field 210c (block 515).

The computing device 110 monitors a hidden field 230 within the display 200 of the terminal emulator 130 for, and receives, an update comprising text 320a previously selected (block 520). The computing device 110 then checks whether a mapping 380 is stored between the text 320a and content 360 previously-selected from previous search results (block 525).

If a mapping 380c is stored between the text 320a and previously-selected content 360b (e.g., the hidden field 230 has previously been updated with text 320a, which has been searched for previously, and subsequently been mapped to content 360b) (block 525, yes), the computing device 110 uses the mapping 380c to identify the content 360b and avoid a further search using the text 320a (block 570). The computing device 110 displays the content 360b and the method 500 ends (block 565).

If no mapping 380c is stored between the text 320a and previously-selected content 360b (block 525, no), the computing device 110 constructs a URL 340 to be used in performing a search (block 530). In some embodiments, to construct this URL 340, the computing device 110 may select a base URL 310 from a plurality of stored base URLs based on one or more of the visible fields 210a-g in the display 200 of the terminal emulator 130, as described above. For example, the computing device 110 may select the base URL 310 based on which of the plurality of stored base URLs is associated with an identifier of the remote mainframe application 140 comprised in visible field 210a (or other visible field 210b-g, according to embodiments). Constructing the URL 340 may further include adding the text 320a to the base URL 310. In some embodiments, the computing device 110 may also add data 330 from one or more of the visible fields 210 to the base URL 310.

The computing device 110 then performs a search using the text 320a as a search term (block 535) and receives a plurality of search results 350 in response (block 540). The computing device 110 displays the search results 350 to the user, e.g., to provide the user with an opportunity to select, from the contents 360a-c therein, content 360b that is relevant to the selected visible field 210c (block 545).

The computing device 110 receives user input selecting content 360b from the plurality of search results 350 (block 550), and stores a mapping 380c between the text 320a and content 360b selected from the plurality of search results 350 (block 555). The computing device 110 then displays the content 360b and the method 500 ends (block 565).

Further embodiments may include repeating one or more of the methods 400, 500 described above in order to, e.g., grow the database 370 of mappings 380 such that each visible field 210 supported by the mainframe application 140 is mapped to corresponding help content 360 over time. Such may, for example, produce a system in which help content 360 may be readily accessed and displayed to a user of the terminal emulator 130 (e.g., without requiring communication over the network 105 every time help is needed for a given visible field 210).

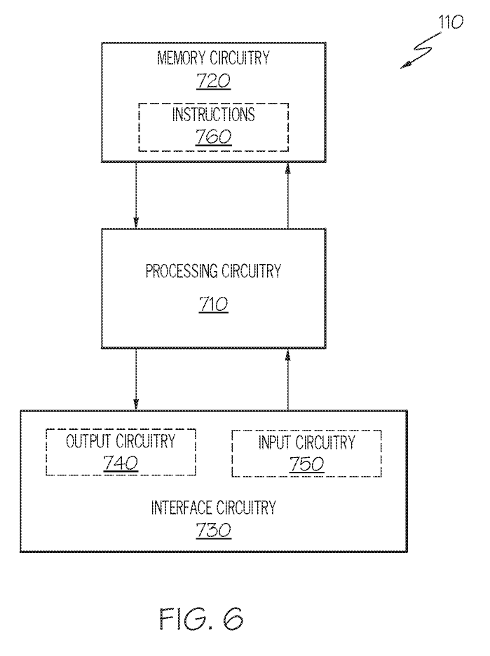

Other embodiments of the present disclosure include the computing device 110 implemented according to the hardware illustrated in FIG. 6. The example hardware of FIG. 6 comprises processing circuitry 710, memory circuitry 720, and interface circuitry 730. The processing circuitry 710 is communicatively coupled to the memory circuitry 720 and the interface circuitry 730, e.g., via one or more buses. The processing circuitry 710 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 710 may be programmable hardware capable of executing software instructions 760 stored, e.g., as a machine-readable computer program in the memory circuitry 720. The memory circuitry 720 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 730 may be a controller hub configured to control the input and output (I/O) data paths of the computing device 110. Such I/O data paths may include data paths for exchanging signals over a communications network 105 and data paths for exchanging signals with a user. For example, the interface circuitry 730 may comprise a transceiver configured to send and receive communication signals over one or more of a cellular network, Ethernet network, or optical network. The interface circuitry 730 may also comprise one or more of a graphics adapter, display port, video bus, touchscreen, graphical processing unit (GPU), display port, Liquid Crystal Display (LCD), and Light Emitting Diode (LED) display, for presenting visual information to a user. The interface circuitry 730 may also comprise one or more of a pointing device (e.g., a mouse, stylus, touchpad, trackball, pointing stick, joystick), touchscreen, microphone for speech input, optical sensor for optical recognition of gestures, and keyboard for text entry.

The interface circuitry 730 may be implemented as a unitary physical component, or as a plurality of physical components that are contiguously or separately arranged, any of which may be communicatively coupled to any other, or may communicate with any other via the processing circuitry 710. For example, the interface circuitry 730 may comprise output circuitry 740 (e.g., transmitter circuitry configured to send communication signals over the communications network 105) and input circuitry 750 (e.g., receiver circuitry configured to receive communication signals over the communications network 105). Similarly, the output circuitry 740 may comprise a display, whereas the input circuitry 750 may comprise a keyboard. Other examples, permutations, and arrangements of the above and their equivalents will be readily apparent to those of ordinary skill.

According to embodiments of the hardware illustrated in FIG. 6, the interface circuitry 730 is configured to exchange signals with a remote mainframe application 140. The processing circuitry 710 is configured to transmit a help key code to the remote mainframe application 140 from a terminal emulator 130 via the interface circuitry 730 while a cursor 220 within a display 200 of the terminal emulator 130 is over a visible field 210c. The processing circuitry 710 is further configured to monitor a hidden field 230 within the display 200 of the terminal emulator 130 for an update. The update comprises text 320a received from the remote mainframe application 140 responsive to the help key code. The processing circuitry 710 is further configured to, responsive to the update, perform a search using the text 320a as a search term.

The present embodiments may, of course, be carried out in other ways than those specifically set forth herein without departing from essential characteristics of the disclosure. For example, it should be noted that the flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, to blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A computer-implemented method comprising:
transmitting a help key code from a terminal emulator to a remote mainframe application while a cursor within a display of the terminal emulator is over a visible field;
monitoring a hidden field within the display of the terminal emulator for an update, the update comprising text received from the remote mainframe application responsive to the help key code;
responsive to the update, performing a search using the text as a search term.

2. The method of claim 1, further comprising:
responsive to performing the search, receiving a plurality of search results;
storing a mapping between the text and content selected from the plurality of search results.

3. The method of claim 2, further comprising responsive to a further update of the hidden field within the display of the terminal emulator, the further update comprising the text, using the mapping to identify the content and avoid a further search using the text.

4. The method of claim 1, further comprising constructing a Uniform Resource Locator (URL) for the search, wherein constructing the URL comprises adding the text to a base URL.

5. The method of claim 4, further comprising selecting the base URL from a plurality of stored base URLs based on a different visible field within the display of the terminal emulator.

6. The method of claim 5, wherein selecting the base URL from the plurality of stored base URLs based on the different visible field comprises selecting the base URL based on which of the plurality of stored base URLs is associated with an identifier of the remote mainframe application comprised in the different visible field.

7. The method of claim 1, wherein transmitting the help key code and receiving the text are each performed via the 3270 protocol.

8. The method of claim 1, wherein transmitting the help key code is responsive to user-selection of the visible field using the cursor and a keypress corresponding to the help key code.

9. The method of claim 1, wherein performing the search using the text as the search term comprises transmitting the text to a remote Internet-based search engine.

10. A computing device comprising:
interface circuitry configured to exchange signals with a remote mainframe application;
processing circuitry communicatively coupled to the interface circuitry and configured to:
transmit a help key code from a terminal emulator to the remote mainframe application via the interface circuitry while a cursor within a display of the terminal emulator is over a visible field;
monitor a hidden field within the display of the terminal emulator for an update, the update comprising text received from the remote mainframe application responsive to the help key code;
responsive to the update, perform a search using the text as a search term.

11. The computing device of claim 10, wherein the processing circuitry is further configured to:
responsive to performing the search, receive a plurality of search results;
store a mapping between the text and content selected from the plurality of search results.

12. The computing device of claim 11, wherein the processing circuitry is further configured to, responsive to a further update of the hidden field within the display of the terminal emulator, the further update comprising the text, use the mapping to identify the content and avoid a further search using the text.

13. The computing device of claim 10, wherein the processing circuitry is further configured to construct a Uniform Resource Locator (URL) for the search, wherein to construct the URL for the search, the processing circuitry is configured to add the text to a base URL.

14. The computing device of claim 13, wherein the processing circuitry is further configured to select the base URL from a plurality of stored base URLs based on a different visible field within the display of the terminal emulator.

15. The computing device of claim 14, wherein to select the base URL from the plurality of stored base URLs based on the different visible field the processing circuitry is configured to select the base URL based on which of the plurality of stored base URLs is associated with an identifier of the remote mainframe application comprised in the different visible field.

16. The computing device of claim 10, wherein the processing circuitry is configured to transmit the help key code and to receive the text each via the 3270 protocol.

17. The computing device of claim 10, wherein the processing circuitry is configured to transmit the help key code responsive to user-selection of the visible field using the cursor and a keypress corresponding to the help key code.

18. The computing device of claim 10, wherein to perform the search using the text as the search term the processing circuitry is configured to transmit the text to a remote Internet-based search engine.

19. A non-transitory computer readable medium storing a computer program product for controlling a programmable computing device, the computer program product comprising software instructions that are executable to cause the programmable computing device to:
transmit a help key code from a terminal emulator to a remote mainframe application while a cursor within a display of the terminal emulator is over a visible field;
monitor a hidden field within the display of the terminal emulator for an update, the update comprising text received from the remote mainframe application responsive to the help key code;
responsive to the update, perform a search using the text as a search term.
